(19) United States
(12) Patent Application Publication
(10) Pub. No.: US 2007/0247252 A1
(43) Pub. Date: Oct. 25, 2007

(54) Ascertaining zero crossing of a carrier waveform for transmitting and receiving signals with substantially no sidebands

(75) Inventor: Daniel L. Lutz, Lexington, KY (US)

Correspondence Address: KING & SCHICKLI, PLLC, 247 NORTH BROADWAY, LEXINGTON, KY, 40507, US

(73) Assignee: Lexel Imaging Systems, Inc.

(21) Appl. No.: 11/401,665

(22) Filed: Apr. 11, 2006

(51) Int. Cl. H04L 27/20

(52) U.S. Cl. 332/103

(57) ABSTRACT

Modulation of signals includes substantially no side bands in a frequency domain. In a device for modulating, a carrier waveform has a sole frequency with positive and negative cyclic portions. Data of an input signal is impressed on the carrier waveform to achieve an output signal. The output signal includes a single frequency waveform at substantially the sole frequency of the carrier waveform and data is impressed on the carrier waveform per either the positive or the negative cyclic portions, but not both. Circuitry for obtaining the output signal includes transitioning the states of the data during either the positive or negative cyclic portions of the carrier waveform opposite the portion upon which the data is to be impressed. Circuitry further includes dividing the carrier waveform into waveforms representing the positive and the negative cyclic portions and for thereafter combining same. In this regard, diodes and amplifiers are contemplated. Transmitters, receivers, systems and communication medium are also disclosed.

### FIELD OF THE INVENTION

The present invention relates to signals having essentially no sidebands in a frequency domain. More particularly, it relates to accurately and regularly ascertaining zero crossings of a carrier waveform to impress data of input signals to create output signals without sidebands. Uniquely arranged output signals include data per only one half of a cyclic waveform. In other aspects, impressing data on carrier waveforms includes circuitry to essentially ensure it occurs with zero crossings. Still other aspects contemplate the communication system itself and devices, such as transmitters and receivers. Hardware and software of such devices are also contemplated.

### BACKGROUND OF THE INVENTION

It has been fairly suggested in the prior art that signals in communication systems can be transmitted and recovered without the signal having any substantial sidebands in the frequency domain. As a result, communication systems have bandwidth that is greatly enlarged for a variety of applications, including radio, television, etc. Among some of the more prominent features in the art, a sine wave carrier with a single frequency includes data impressed thereon per every half or full wave cycle of the sine wave. In this regard, data is expressed as one amplitude for a binary zero and another, higher amplitude for a binary one per every half or full cycle of the sine wave. Alternatively, data is expressed as one amplitude for a 00 value, a higher amplitude for a 01 value, a still higher amplitude for a 10 value and a highest amplitude for a 11 value per every half or full cycle of the sine wave. In other embodiments, binary data is represented on a single frequency sine wave by turning the sine wave on or off after every full wave cycle thereof. Binary ones then represent the presence of the sine wave while binary zeros represent the absence of the sine wave. Still other data impression schemes include quantizing amplitudes of a data or information signal and resetting the amplitude of a single frequency carrier sine wave to match the quantized amplitudes per every full cycle of the carrier, especially at times when amplitudes of the carrier have relatively no energy, such as when it crosses the x or time axis of a mathematical representation of same.

Regardless of scheme, communication systems involved with signals having no sidebands are dependent upon ascertaining the time or position when the carrier has little or no energy for impressing data thereon. As some have called it, it is “zero-crossing” of the carrier that is important, e.g., when the carrier 10, FIG. 1, crosses the x or time t axis at positions 12, 14, 16, 18, 20, etc., for example. However, accurately and regularly obtaining the zero-crossing is somewhat difficult in practice, especially considering the impreciseness of components and that carrier frequencies are often found of the megahertz magnitude.

Accordingly, the art of modulating/demodulating signals with no sidebands has need of improved ascertainment of the zero-crossing of the carrier. Furthermore, the improvement need contemplate hardware devices, such as transmitters, receivers, components, ASIC's etc., software, firmware, controllers and/or combinations thereof. Naturally, any improvements should further contemplate good engineering practices, such as relative inexpensiveness, low power consumption, ease of manufacturing, low complexity, etc.

### SUMMARY OF THE INVENTION

The above-mentioned and other problems become solved by applying the principles and teachings associated with the hereinafter described methods and apparatus for ascertaining zero crossings of a carrier waveform, especially in communication systems transmitting and receiving signals having essentially no sidebands. Broadly stated, this includes uniquely arranged output signals and circuitry essentially ensuring data is fairly impressed on the carrier waveform at the zero crossing.

In one aspect, devices for transmitting signals include a carrier waveform with a sole frequency and positive and negative cyclic portions. Data of an input signal is impressed on the carrier waveform to achieve an output signal. The output signal includes a single frequency waveform at substantially the sole frequency of the carrier waveform and data is impressed on the carrier waveform per either the positive or the negative cyclic portions, but not both. Circuitry for obtaining the output signal includes ensuring transitions of the states of the data occur during either the positive or negative cyclic portions of the carrier waveform opposite the positive or negative cyclic portions upon which the data is to be impressed.

In other aspects, circuitry further includes dividing the carrier waveform into discrete waveforms representing the positive and the negative cyclic portions and for combining same thereafter. In this regard, it can be relatively assured that the data will be impressed per an appropriate cyclic portion of the carrier waveform. Diodes are representatively contemplated and one diode conducts during either the positive or negative cyclic portion of the carrier waveform and another diode conducts during the other portion of the positive or negative cyclic portion. An amplifier output resides between the diodes and the diodes are biased toward and away from the output. Switching from one diode conducting to the other diode conducting occurs when the carrier waveform transitions from the positive cyclic portion to the negative cyclic portion, and vice versa. In a representative embodiment, carrier waveforms embody sine waves as do the output signals. The input signal is any type of waveform and may include multiple or single frequencies. Naturally, circuitry includes discrete components, ASIC's, software, firmware and/or combinations thereof. Transmitters, receivers and communication medium are also contemplated.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a graph of a carrier in accordance with the prior art;

FIGS. 2A-2H are graphs in accordance with the present invention of representative signals in a communications system for use in modulating signals with substantially no sidebands in a frequency domain;

FIG. 3 is a diagrammatic view in accordance with the present invention of a portion of a representative transmitter in a communications system for ascertaining zero crossings of a carrier waveform useful in transmitting and receiving signals with substantially no sidebands in a frequency domain;

FIG. 4 is a diagrammatic view in accordance with the present invention of a representative transmitter in a communications system for transmitting and receiving signals with substantially no sidebands in a frequency domain; and

FIG. 5 is a diagrammatic view in accordance with the present invention of a communications system for (de)modulating signals with substantially no sidebands in a frequency domain.

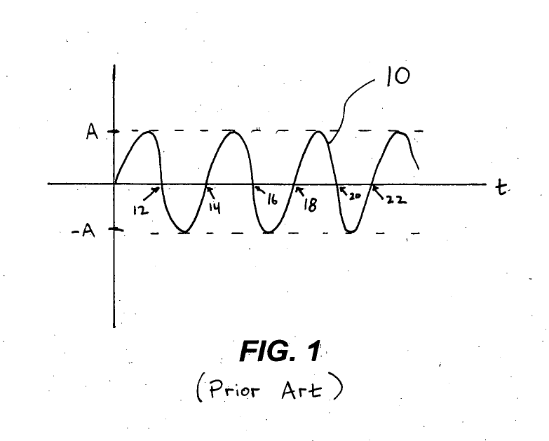

### DETAILED DESCRIPTION OF THE PREFERRED EMBODIMENTS

In the following detailed description of the preferred embodiments, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that process, electrical, software, or mechanical, etc. changes may be made without departing from the scope of the present invention. In accordance with the present invention, methods and apparatus for ascertaining zero crossings of a carrier waveform, especially in communication systems transmitting and receiving signals having essentially no sidebands are hereinafter described.

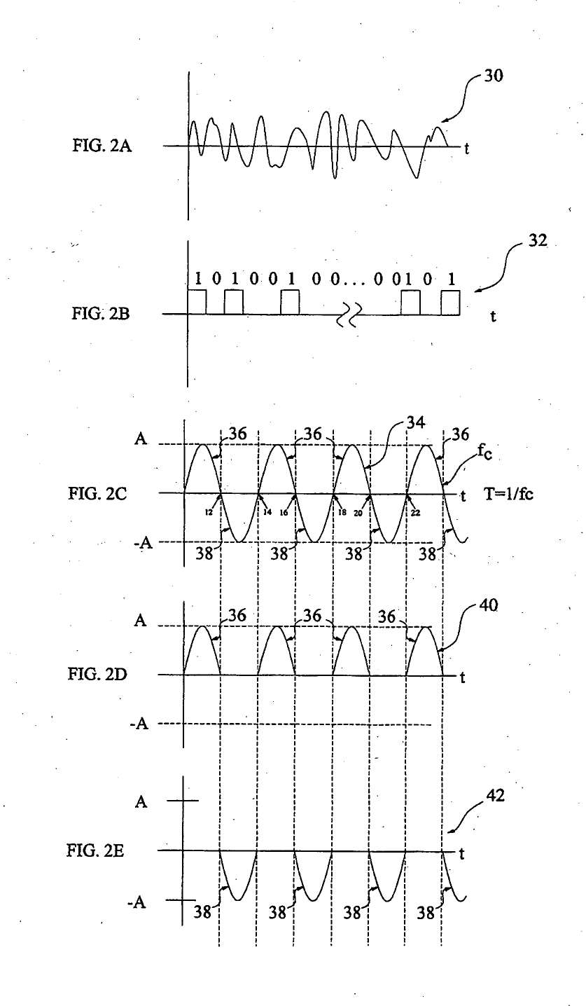

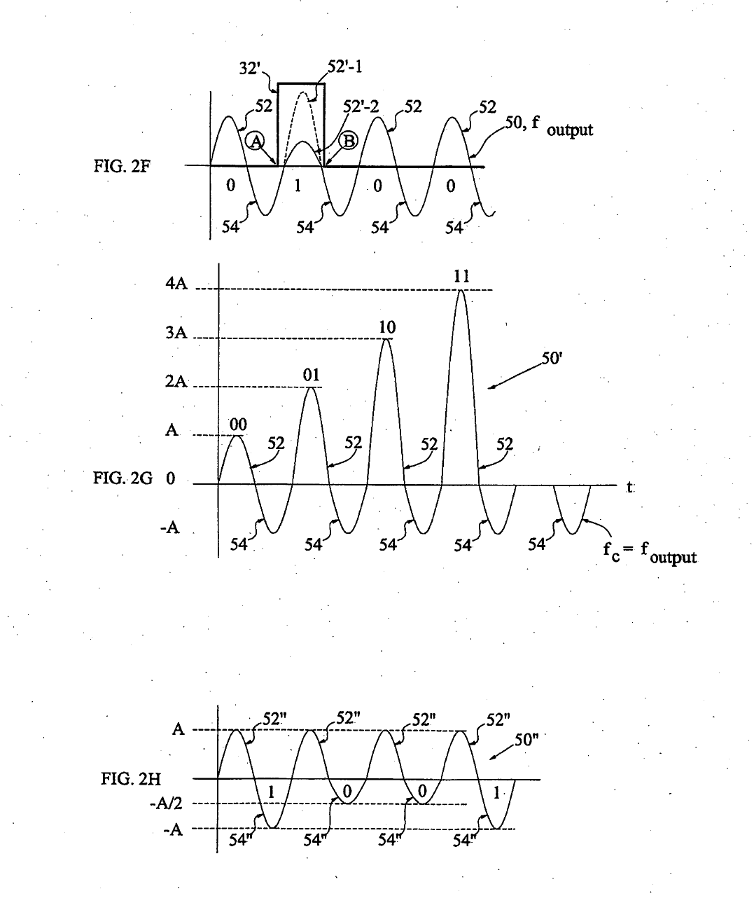

With reference to FIGS. 2A-2H, representative signals for use in understanding the invention are presented. In FIG. 2A, an input signal 30 has data or information therein and includes multiple or single frequencies. It is received, obtained or otherwise created for transmission over a communications path to a receiver where it is demodulated and the data or information recovered. As shown, the input signal typifies a voice signal on the order of about 2-20 kHz. In other embodiments, however, input signals may include, but are not limited to, television, telephone, internet, intranet, security, facsimile, video conferencing, and the like and all are well known.

In FIG. 2B, after processing the input signal, the data is extracted and can be represented as a data waveform 32. In one embodiment, this amounts to quantizing or digitizing the input signal and extracting a waveform with voltage, frequency, and states complimentary of the system in which it is used. Preferably, this amounts to a serial bit stream output having two or more logic states. As given, the serial bit stream includes two states of bits, logic 1 or logic 0, and are serially concatenated as 1, 0, 1, 0, 0, 1, 0, 0, . . . etc. Naturally, other data waveforms or signals are contemplated as are other mechanisms for extracting it from the input signal.

In FIG. 2C, a carrier waveform 34 of the invention includes positive and negative cyclic portions 36, 38 ranging in amplitude between +A. Generally stated, that which lies above the time t axis is a positive cyclic portion 36 and that which lies below it is a negative cyclic portion 38. Its frequency is also a singular or sole frequency at f_{c} with period T equaling l/f_{c}. In practice, the carrier waveform is an essentially pure sine wave having a frequency on the order of about 10-20 MHz. In other embodiments, the frequency is on the order of a few hertz, such as 30 Hz, and ranges to 30 GHz, or more. It may also be embodied as other than a sine wave.

In FIGS. 2D and 2E, at least two waveforms 40, 42 are obtainable or derivable from the carrier waveform. That is, waveform 40 represents the positive cyclic portions 36 while waveform 42 represents the negative cyclic portions 38. In this manner, the data waveform can be used with these waveforms to fairly precisely impress itself on the carrier waveform. Stated differently, these waveforms are useful in ascertaining the zero crossings of the carrier waveform. Various circuits or circuitry will also be identified in this regard. Duty cycles of these waveforms are substantially one-half.

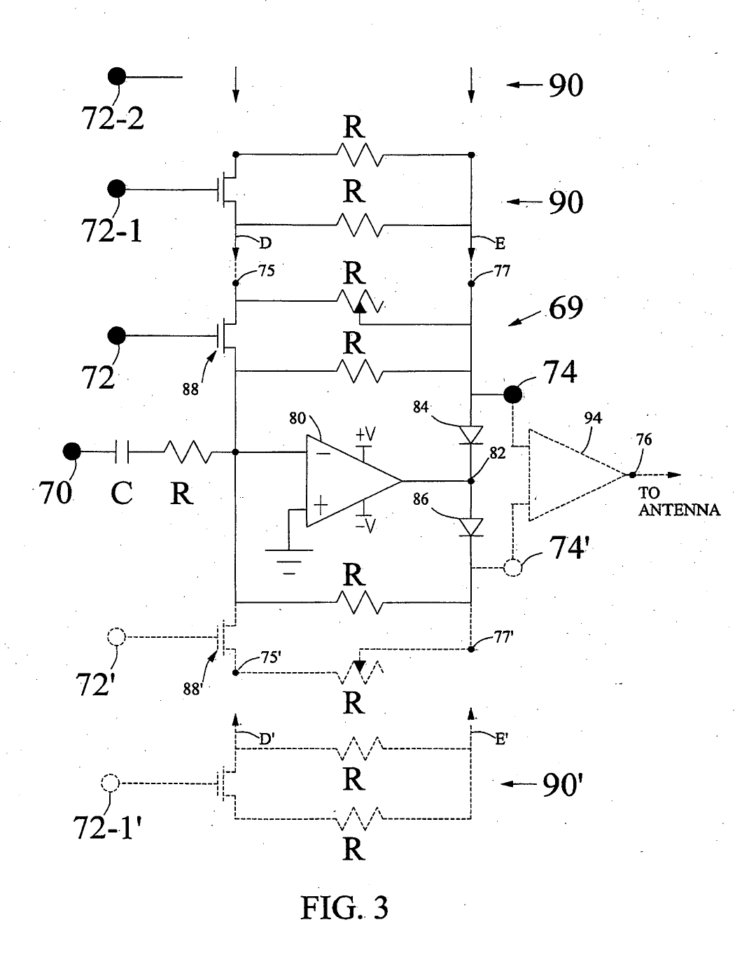

With reference to FIG. 2F, an output signal in accordance with the invention is given as 50. Among other things, the output signal 50 includes a sine waveform with a single frequency, fₒᵤₜₚᵤₜ, which is substantially equal to the frequency, f_{c}, of the carrier waveform. The output signal also includes positive and negative cyclic portions 52, 54 residing generally above or below the time t axis, respectively. On either the positive or negative cyclic portions, data of the input signal is found that was impressed on the carrier waveform to arrive at the amplitude of the output signal. For example, a representative data waveform 32′ of the invention is superimposed on the output signal 50 and includes a serial bit stream given as 0, 1, 0, 0. Its transition from 0 to 1 or 1 to 0 occurs during that portion of the positive or negative cyclic portion of the carrier waveform opposite that portion of the positive or negative cyclic portion of the output signal in which data is to be impressed. As is seen, the amplitude of the data waveform 32′ transitions from a 0 to 1 at time A and from 1 to 0 at time B. As will be described below, this occurs, and is relatively assured to occur, because of characteristics of the bifurcated carrier waveform into waveforms 40, 42 of both the positive and negative cyclic portions of the carrier waveform (FIGS. 2D, 2E). In comparison to the data waveform, the output signal at times A and B both correspond to a sine waveform in its negative cyclic portion 54. Thus, the data impression on the output signal occurs on the portion of the waveform opposite the negative cyclic portion 54, or the positive cyclic portion 52. As is further seen, the data is impressed on the particular cycle of the positive cyclic portion given as 52′. The positive cyclic portion 52′ differs from the other positive cyclic portions 52 in amplitude and thusly represents data that can be recovered and reconstructed after modulation from a transmitter to a receiver. Also, the positive cyclic portion 52′ can be either 52′-1 (dashed line view) or 52′-2 (solid line view) higher or lower than the other three amplitudes of the positive cyclic portions 52 depending upon the particular design of a circuit, and because the representative data waveform includes three bits of one value (0) and one bit of another value (1). To achieve amplitude 52′ as either a logic 1 or 0, inverters or other circuitry may be used. Lastly, FIG. 2F represents a waveform output from an actual circuit experiment having components similar to those in FIG. 3.

With reference to FIG. 2G, an alternate output waveform of the invention is given as 50′. In this regard, data or information of the input signal is found with other than binary states. For example, output signal 50′ shows multiple levels (0 (or off), +A, +2A, +3A, +4A, etc.) of amplitude that were impressed on a carrier waveform of a single frequency, f_{c}, with an output signal being given at a single frequency, fₒᵤₚᵤₜ, substantially equal to the carrier waveform frequency. The notion is similar to QAM and 16 levels to 256 levels of amplitude, or more, are embraced herein. Also, while the output signal 50′ is shown with information or data impressed per the positive cyclic portions 52, information or data can be impressed per the negative cyclic portion 54 in lieu of the positive cyclic portion. For example, FIG. 2H shows data of 1, 0, 0, 1 being impressed on a carrier waveform to arrive at an output signal 50″ with the negative cyclic portions 54″ showing the data while the positive cyclic portions 52 contain no data and are relatively consistently in amplitude at +A. It should be appreciated that because the cyclic half of the output signal with the data impressed therein varies, while the opposite half or cyclic portion remains constant, the non-data cyclic portion can be used as a baseline amplitude for which discerning states of data in the other half can be ascertained. For example, if the non-data cyclic portion of the output signal had an amplitude at +A, and the data cyclic portion of the output signal had amplitudes at either −A and −0.5 A, as seen in FIG. 2H, a receiver or demodulator could be built such that the full −A swings in amplitude correspond to a logic 1 while the −0.5 A swings correspond to a logic 0 as shown. The +A, on the other hand, would be used to compare to the −A to set the baseline. Alternatively, the non-data cyclic portion of the output signal could also be used to imbed various identification codes. In this manner, individual receivers could be built, for instance. Naturally, skilled artisans can contemplate other usages for the non-data cyclic portion of the output signal relative to the data cyclic portion.

Having shown and described various waveforms useful in the invention, FIG. 3 shows representative circuitry 69 for accomplishing same. At node 70, the invention contemplates a carrier waveform, such as that of FIG. 2C. At node 72, a data waveform, such as that of FIG. 2B, is contemplated for impressing on the carrier waveform, with the proviso that the data waveform is shifted or otherwise confirmed as having state transitions occurring at the same time as the positive or negative cyclic portions of the carrier waveform opposite the portion upon which data is to be impressed. At node 76, the output signal of the invention, such as that shown in one or more of FIGS. 2F-2H, is found. Upstream of the output signal, is node 74. At this node, one half of the carrier waveform is found with the data from node 72 impressed thereon. The waveform at this point appears similar to the waveform 40 of FIG. 2D for the positive cyclic portions 36 of the carrier waveform. To the extent data exists in a data waveform at node 72, it too will appear in the positive cyclic portion. At node 74′, in phantom, this is where the negative cyclic portion 38 of the carrier waveform would appear, such as shown in FIG. 2E.

With more specificity, an amplifier 80 includes an output 82 between two diodes 84 and 86. One diode 84 is biased toward the output and one diode 86 is biased away from the output. In turn, during positive cyclic portions of the carrier waveform, the diode 84 biased toward the output conducts and during negative cyclic portions of the carrier waveform, the diode 86 biased away from the output conducts. Also, transitions between one diode conducting and the other diode conducting occur when the carrier waveform transitions from its positive cyclic portion to its negative cyclic portion, and vice versa. In other words, the diodes switch in their conducting when the carrier waveform has a zero-crossing or transits the time axis at 12, 14, 16, 18, etc., (e.g., FIG. 2C).

With this in mind, a switch 88 in the form of a transistor (FET, in this instance) serves to gate or impress the data onto the carrier waveform. In this manner, the output signal will have data impressed per every positive cyclic portion of the carrier waveform. To the extent it is desired that the negative cyclic portion of the carrier waveform include data impressed thereon, a node 72′ with a switch 88′ is given in phantom and such is generally the reverse of the circuit given in other than phantom. Also, a variety of fixed or variable resistors R of the same or different values are provided, as are other circuit components, such as a capacitor C or other components (not shown).

To the extent a multi-level output signal is desired, such as that shown in FIG. 2G, multiple stages 90 of switching networks with parallel input sources 72-1, 72-2, could be cascaded together as shown by Arrows D, E to connection nodes 75, 77. In phantom, Arrows D′ and E′ are given in the event the multi-level output signal is desired per the negative cyclic portions of the carrier waveform. In either event, an amplifier 94 or other joining component serves to combine the divided or bifurcated positive and negative cyclic waveforms of the carrier waveform to produce the output signal.

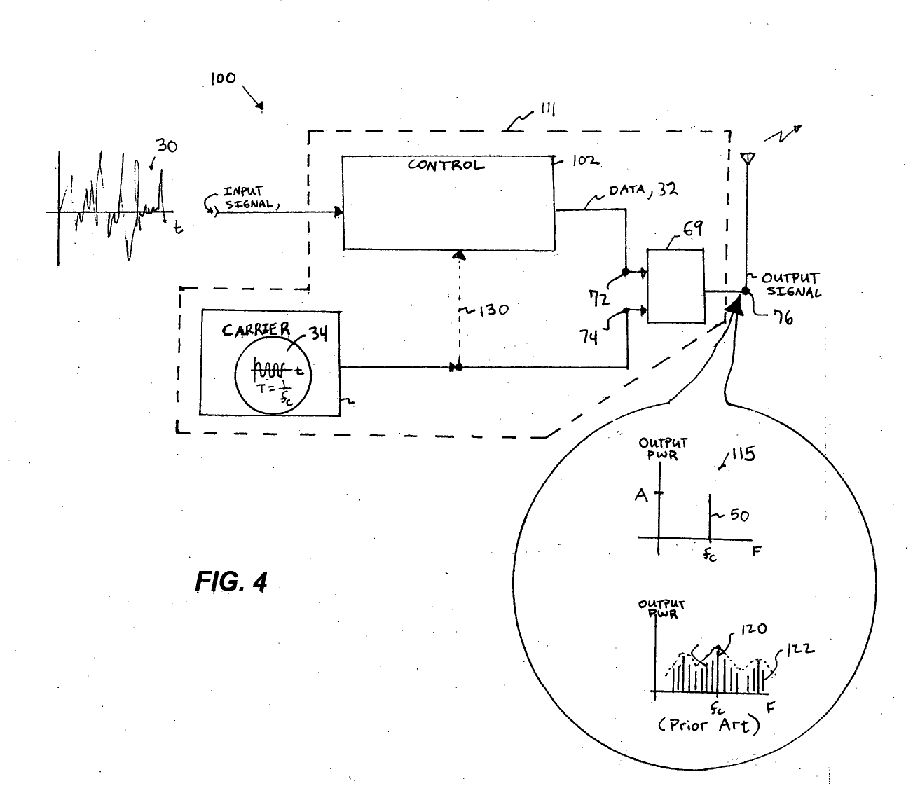

In FIG. 4, a transmitter of the invention in a communications system involved in the transmission/reception of signals having relatively no sidebands in the frequency domain is given as 100. The output signal is that already described at node 76 after the inputs at nodes 72 and 74 are acted upon by circuitry 69. The input signal 30 and carrier waveform 34 also include that already described and the data waveform 32 is the result of control circuitry 102 that adjusts the data of the input signal into transitioning properly per either the appropriate positive or negative cyclic portion of the carrier waveform. In this regard, the control circuitry 102 (as well as all other circuitry of the invention, including circuitry 69) typifies individual components, such as microprocessors, analog-to-digital converters, delay elements, inverters, logic gates, shift registers, clocks, counters, operational amplifiers, buffers, printed circuit boards, conductors, etc., integrated components, such as application specific integrated circuits (ASIC's), software, firmware and/or combinations thereof. Naturally, skilled artisans can contemplate other designs and the dashed line 111 serves to illustrate a broader scope of the circuitry. Referring to the inset, a diagrammatic spectrum analyzer output 115 shows the output signal at node 76 in an output power plot versus frequency with the output signal 50 having amplitude A centered at the frequency f_{c} of the carrier 34. Compared to prior art modulation of signals, such as signal 120, sidebands 122 of the output signal 50 are essentially avoided.

Optionally, at dashed line 130, via hardware (discrete and/or integrated components), and/or software/firmware and/or combinations thereof, a control signal is derived from the carrier 34. In turn, the control signal controls the circuitry 102 of the transmitter. In this manner, separate circuitry for producing an independently created clocking signal is unnecessary. Also, the independent clock need not be transmitted with the output signal to an attendant receiver for use in demodulation. This avoids complexity and saves system bandwidth/capacity. Further, it tends to ease manufacturing constraints and minimizes costs. For a more complete discussion of this topic, reference is made to U.S. patent application Ser. No. 11/354,736, filed Feb. 15, 2006, entitled “Control for Communication Systems Transmitting and Receiving Signals with Substantially No Sidebands,” and its entirety is hereby incorporated by reference.

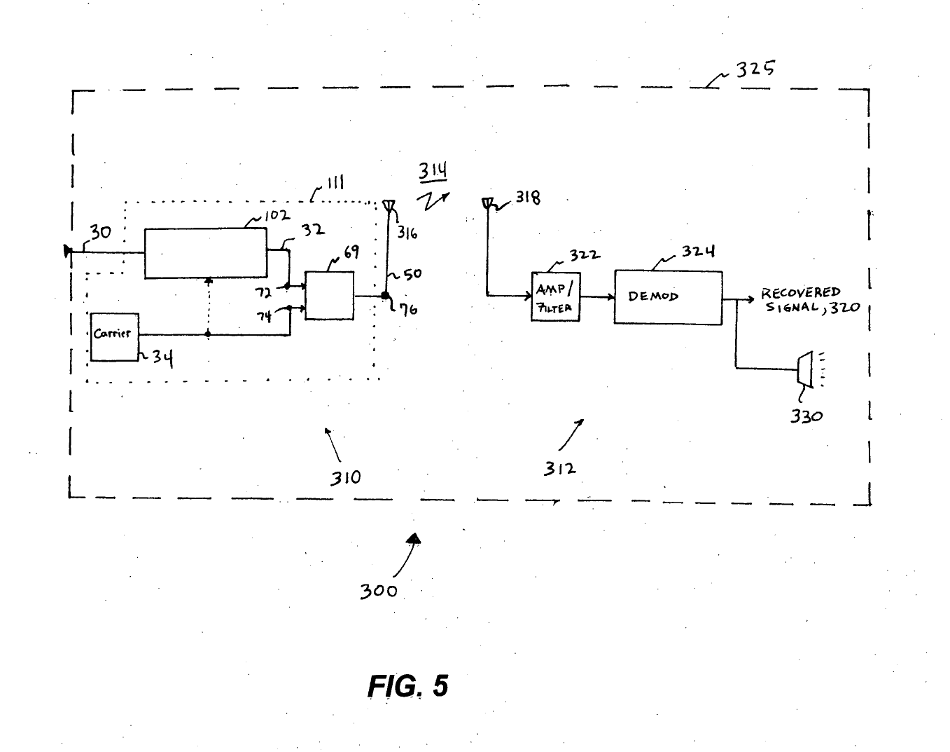

With reference to FIG. 5, a representative communications system of the invention is given as 300. In one aspect, a transmitter 310 is separated from a receiver 312 via a communications medium 314 between transmit and receive antennas 316, 318. In another aspect, the transmitter and receiver are contained in a single unit device, e.g., a transceiver, given by the dashed line 325 with a single antenna likely replacing the two antennas shown and the communications medium being external to the transceiver. In either event, data of an input signal 30 is impressed on a carrier 34 in the manner previously described and transmitted to a receiver. Upon reception, the input signal becomes a recovered signal 320 after various processing, such as signal amplification and filtering 322 and demodulation 324. The recovered signal can then be used, such as by displaying, listening, etc. at 330. Also, a preferred communications medium 314 includes air, space, ground (e.g., earth), water, wires, conductors, repeating stations, or the like. Various platforms, such as base stations, homes, buildings, airplanes, submarines, trains, automobiles, etc., can also house the transmitter, receiver, transceiver, etc.

In a larger perspective, a communications system of the invention may include transmitters, receivers, repeating stations, satellites, computers, transceivers, etc. To fairly make, use and sell transmitters, receivers, transceivers, etc. in embodiments, such as cell phones, radios, televisions, and computers, for individual use, it is contemplated that each transmitter has its own tuned frequency, e.g., 10.000 MHz so that demodulation occurs exactly at the same frequency. In turn, the next sold item has a tuned frequency of 10.001 MHz with the next being 10.002 MHz and so on. While most conventional communications systems, due to limited bandwidth, are unable to achieve such functionality, it should be appreciated this departs from the conventional wisdom because bandwidth of signals having essentially no sidebands is so precise that unrelated components can have exceptionally close spectral parameters without causing interference. In turn, millions of precisely and uniquely tuned items can be purchased and sold. Alternatively, various frequency identifiers can be embedded in modulated signals (such as the non-data cyclic portion of the output signal) of purchased items such that upon reception, the identifier is first learned and then demodulated, to get a recovered signal, at the frequency specified by the identifier. In still other embodiments, combinations of the two are possible. Naturally, skilled artisans can envision other feasible designs. In still other embodiments, the advantages of the invention, especially output signal waveforms having a single frequency with data impressed per either the positive or negative cyclic portions or for synching the transition of data to occur per the opposite cyclic portion upon which data is to be impressed, can be utilized in typical communication systems including, but not limited to, FM, AM, PSK, QAM, and the like.

Finally, the foregoing description is presented for purposes of illustration and description of the various aspects of the invention. The descriptions are not intended, however, to be exhaustive or to limit the invention to the precise form disclosed. Accordingly, the embodiments described above were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. In a device for modulating signals in a communications system, comprising:
a carrier waveform having a sole frequency including positive and negative cyclic portions; and
an output signal having a single frequency at the sole frequency representing data impressed on the carrier per either the positive or the negative cyclic portions for transmitting from the device.

2. The device of claim 1, further including circuitry for receiving an input signal with the data for impressing on the carrier waveform.

3. The device of claim 1, wherein the carrier waveform is substantially a sine wave.

4. The device of claim 1, further including circuitry for dividing the carrier waveform into at least two waveforms representing the positive and the negative cyclic portions.

5. The device of claim 4, further including circuitry for combining the at least two waveforms.

6. The device of claim 4, wherein the circuitry includes a plurality of diodes, one of the diodes conducting during the positive cyclic portions and another of the diodes conducting during the negative cyclic portions.

7. The device of claim 6, wherein switching from the one diode conducting to the another diode conducting occurs when the carrier waveform transitions from the positive cyclic portion to the negative cyclic portion.

8. The device of claim 6, further including an amplifier with an output between the one diode and the another diode.

9. The device of claim 1, wherein the output signal has substantially no side bands in a frequency domain.

10. The device of claim 1, further including circuitry to transition states of the data impressed on the carrier per said either the positive or the negative cyclic portions of the carrier waveform during an opposite portion of the positive or the negative cyclic portions of the carrier waveform.

11. In a communications device, a method of transmitting data of an input signal having one or more frequencies with a carrier waveform having a sole frequency, comprising: impressing the data on either a positive or negative cyclic portion of the carrier waveform to form an output signal for transmission from the communications device, the output signal having a single frequency substantially equal to the sole frequency.

12. The method of claim 11, further including dividing the carrier waveform into at least two waveforms representing the positive and the negative cyclic portions.

13. The method of claim 12, further including combining the at least two waveforms.

14. The method of claim 12, further including conducting one of a plurality of diodes during the positive cyclic portions and conducting another of the diodes during the negative cyclic portions.

15. The method of claim 14, further including switching from the one diode conducting to the another diode conducting when the carrier waveform transitions from the positive cyclic portion to the negative cyclic portion.

16. The method of claim 11, further including transitioning states of the data impressed on the carrier waveform during the positive or the negative cyclic portions of the carrier waveform opposite the positive or the negative cyclic portions of the carrier waveform upon which the data is impressed.

17. The method of claim 11, further including transmitting the output signal without any substantial sidebands in a frequency domain.

18. In a communication system, a method of modulating a signal having substantially no side bands in a frequency domain, comprising:
receiving an input signal having data, the input signal having one or more frequencies;
establishing a carrier waveform having a sole frequency with positive and negative cyclic portions; and
transitioning states of the data during the positive or the negative cyclic portions of the carrier waveform opposite the positive or the negative cyclic portions of the carrier waveform upon which the data is to be impressed.

19. The method of claim 18, further including impressing the data on either the positive or the negative cyclic portion of the carrier waveform to form the signal having substantially no side bands in the frequency domain, the signal having a single frequency substantially equal to the sole frequency.

20. The method of claim 18, further including dividing the carrier waveform into at least two waveforms representing the positive and the negative cyclic portions.

21. The method of claim 20, further including combining the at least two waveforms back into the signal.

22. The method of claim 20, further including switching the conducting from one diode of a plurality of diodes to another diode when the carrier waveform transitions from the positive cyclic portion to the negative cyclic portion.

23. In a device for modulating signals in a communications system, comprising:
a carrier waveform having a sole frequency including positive and negative cyclic portions;
data having one or more states for impressing upon the carrier waveform to create an output signal; and
a control circuit to transition the states of the data during either the positive or the negative cyclic portions of the carrier waveform.

24. The device of claim 23, wherein the output signal has positive and negative cyclic portions with a single frequency substantially equal the sole frequency and the data is represented on the output signal per either the positive or the negative cyclic portions and is opposite the positive or the negative cyclic portions of the carrier waveform that corresponds to the transition of the states of the data.

25. The device of claim 23, further including circuitry for receiving an input signal with the data, the input signal having one or more frequencies.

26. The device of claim 23, further including circuitry for dividing the carrier waveform into at least two waveforms representing the positive and the negative cyclic portions.

27. The device of claim 26, further including circuitry for combining the at least two waveforms back into the output signal.

28. The device of claim 26, wherein the circuitry includes a plurality of diodes, one of the diodes conducting during the positive cyclic portions of the carrier waveform and another of the diodes conducting during the negative cyclic portions of the carrier waveform.

29. The device of claim 28, wherein the circuitry causes switching from the one diode conducting to the another diode conducting when the carrier waveform transitions from the positive cyclic portion to the negative cyclic portion.

30. The device of claim 28, further including an amplifier with an output between the one diode and the another diode.

31. The device of claim 24, wherein the output signal has substantially no side bands in a frequency domain.
